(19) United States
(12) Patent Application Publication
(10) Pub. No.: US 2004/0265560 A1
(43) Pub. Date: Dec. 30, 2004

(54) Rubber systems for reinforcing surfaces

(76) Inventors: Ralf Sauer, St. Leon-Rot (DE); Martin Hornung, Heidelberg (DE); Severine Cadou, Consne-sur-Loire (FR); Laurence Deripps, Pau (FR)

Correspondence Address: HENKEL CORPORATION, THE TRIAD, SUITE 200, 2200 RENAISSANCE BLVD., GULPH MILLS, PA, 19406, US

(21) Appl. No.: 10/868,698

(22) Filed: Jun. 15, 2004

Related U.S. Application Data
(63) Continuation of application No. PCT/EP02/14121, filed on Dec. 12, 2002.

(30) Foreign Application Priority Data
Dec. 21, 2001 (DE) 101 63 252.5

(51) Int. Cl. B32B 27/12; B32B 5/16

(52) U.S. Cl. 428/297.4; 428/299.4; 428/299.7; 428/301.4; 428/521; 428/523

(57) ABSTRACT

Thermosetting binder compositions based on naturally occurring and/or synthetic rubbers containing olefinic double bonds and vulcanizing agents can be formed by extrusion on reinforcing agents in film form or in the form of fiber-containing sheet-like structures to give multi-layered planar shaped articles. Such multi-layered, planar shaped articles are suitable as reinforcing and stiffening agents which are free from the conventional low molecular weight epoxy resins and/or volatile diisocyanates of polyurethane binders. These shaped articles are suitable for stiffening or reinforcing thin-walled planar structural components of metal or plastic, in particular in the vehicle industry.

This application is a continuation under 35 USC Sections 365(c) and 120 of International Application No. PCT/EP02/14121, filed 12 Dec. 2002 and published 3 Jul. 2003 as WO 03/0053687, which claims priority from German Application No. 10163252.5, filed 21 Dec. 2001, each of which is incorporated herein by reference in its entirety.

### FIELD OF THE INVENTION

The invention relates to thermosetting, multi-layered planar shaped articles comprising at least one thermosetting binder layer and at least one layer of a reinforcing agent, a process for the production thereof, their use and a process for stiffening and/or reinforcing planar vehicle body components.

### DISCUSSION OF THE RELATED ART

As a result of improved corrosion protection for metallic substrates, easier shaping of these thin substrates and lower costs and especially because of the saving in weight and the associated saving in fuels during operation of such vehicles of lightweight construction, the use of thin rigid strips, plates or metal sheets in vehicle construction has greatly increased in recent times. In the past, metallic stiffening plates were either welded or glued on to the thin metal sheets for stiffening. Because of the above-mentioned requirement of saving in weight, the demand for lightweight sheet and frame stiffening systems for the most diverse uses in automobile construction is very high. In addition to the abovementioned metal plates, laminated body systems based on epoxy resins and/or polyurethanes have hitherto been disclosed for these fields of use.

U.S. Pat. No. 4,444,818 thus describes a thermosetting adhesive laminated body which is built up from a thermosetting resin layer in the form of a “prepreg” and in which a reinforcing material is embedded. This specification furthermore proposes attachment to one side of the prepreg of a flattened tubular material which can resume its original tubular shape when the reinforcing laminated body is heated. The prepreg laminated body can comprise two different thermosetting resin layers. Epoxy resins are proposed as binders for the thermosetting layers of the prepreg. The tubular or hose-like body here is said to be made of polyethylene, ethylene/vinyl acetate copolymers, polypropylene, polystyrene or PVC or also nitrile rubber. The production process for such reinforcing laminated bodies is expensive.

EP-A-230666 describes a process for the production of a one-component thermosetting composition which forms a urethane-epoxy-silicone interpenetrating network (IPN) system on heating. This specification proposes production, from these compositions, of metal-reinforcing laminated bodies (“patches”) which adhere directly to oil-containing metal surfaces, such as oily steel sheets. The IPN is said to be formed here by a polyepoxy compound, a blocked polyamine curing agent and a chain-lengthened polyurethane prepolymer in which some isocyanate groups of the prepolymer are blocked with a hydroxy-functional polysiloxane.

EP-A-297036 describes a laminated body comprising a support, e.g., resin-bonded glass fiber fabric, to which a layer of thermosetting resin is applied. To protect the tacky resin surface, a cover film of a material which shrinks under the action of heat is envisaged. This film should be provided with slits which widen to open after a heat pretreatment, so that part of the tacky surface is exposed. By this means it is said to be no longer necessary to peel off the protective film before application of the laminated body. No information is given regarding the composition of the tacky resin layer.

EP-A-376880 describes a laminated body arrangement for stiffening planar bodies comprising a carrier layer of a curable synthetic resin material in which a reinforcing material bonded thereto or embedded therein is provided. An adhesive layer which comprises a curable synthetic resin material optionally provided with fillers and other additives and is applied to the carrier layer and faces the body to be stiffened is furthermore proposed. To achieve the highest possible reinforcing effect without deformation of the planar body (metal sheet), the adhesive layer should have a higher elasticity modulus after curing of the synthetic resin than the cured synthetic resin material of the carrier layer, and at the same time the carrier layer and adhesive layer in the cured state should have at least approximately the same coefficient of thermal expansion as the planar body to be stiffened. The carrier layer here should comprise a glass fiber fabric and a mixture of liquid epoxy resins and solid epoxy resins and curing agents, and the adhesive layer should substantially comprise thermosetting, self-adhesive synthetic resins and is likewise built up from liquid and solid epoxy resins as well as curing agents and fillers.

EP-A-298024 similarly describes a process for stiffening metal sheets and shaped articles of plastic with the aid of a single- or multi-layered planar stiffening body in which at least one layer comprises a synthetic resin which cures under the influence of heat. This stiffening body here should initially be subjected to a first heat treatment, during which at least one surface of the stiffening body becomes tacky as a result of this first heat treatment. The stiffening body should then be applied with the tacky surface to the element to be stiffened and the stiffening body should then be subjected to a second heat treatment, until all the layers of the stiffening body have cured. It is proposed that a layer of the reinforcing body is built up from thermosetting epoxy resins and optionally comprises glass fiber fabric. An epoxide-based hot-melt adhesive, possibly based on polyurethane or copolyester, is proposed as the second layer which should become tacky during the first heat treatment. Alternatively, this layer should comprise a film which shrinks under the action of heat, so that a tacky layer is exposed after shrinkage.

WO 95/27000 describes a curable, injection-moldable composition for reinforcing thin, hard sheets of metal or plates. The composition is built up from thermosetting resins, expandable hollow microbeads and particulate reinforcing material of ground glass fibers, ground carbon fibers and mixtures thereof. The various epoxy resins based on glycidyl ethers, glycidyl esters or glycidylamines are proposed as the thermosetting resin compositions.

CA-A-2241073 describes a film reinforcing stiffening laminate for rigid, thin-walled substrates. According to the doctrine of this specification, the polymer should cure with expansion in a lacquering oven and thereby bond intimately with the inner surface of the base substrate to be reinforced. No information regarding the binder composition is given in this specification.

As can be seen from the prior art described above, the sheet- or frame-stiffening laminated bodies are substantially limited to epoxy-based systems and systems based on polyurethanes. These indeed as a rule meet the required stiffening performance, but do not meet the demand for a chemical system which is industrially hygienic and acceptable from the health point of view. As is known, epoxy systems based on liquid epoxy resins comprise low molecular weight epoxide compounds with a molecular weight of below 700. The use of such epoxy compositions is undesirable for industrial hygiene reasons, since these low molecular weight epoxide compounds can cause allergic or sensitizing reactions in contact with skin. Reactive polyurethane systems as a general rule still contain residues of monomeric diisocyanates. For this reason workplaces must be appropriately equipped with exhaust equipment if such compositions are used, in order to be able to protect the persons employed at these workplaces from exposure to isocyanates. In view of this prior art, the inventors had the object of providing sheet-stiffening, thermosetting shaped articles which are free from low molecular weight epoxide compounds and free from isocyanates.

### SUMMARY OF THE INVENTION

The present invention provides multi-layered, planar shaped articles built up from at least one thermosetting binder layer and at least one layer of reinforcing agents, the binder layer comprising naturally occurring and/or synthetic rubbers containing olefinic double bonds and vulcanizing agents.

The present invention also provides a process for stiffening or for reinforcing planar structural components of metal or plastic which comprises:

a) Application of the thermosetting binder layer based on naturally occurring and/or synthetic rubbers containing olefinic double bonds and vulcanizing agent to the reinforcing agent; and

b) Optionally, application of a protective film to the binder layer if this is tacky at room and storage temperature.

The shaped articles produced in this way can optionally be intermediately stored or transported to the end user, as a rule the automobile producer. The protective film optionally present is removed from the binder layer there and the shaped article is then applied to the structural component to be reinforced or to be stiffened, and curing of the binder is carried out at temperatures of between 110° C. and 210° C., preferably between 130° C. and 180° C., in the lacquer drying ovens, as a rule in the oven for curing the electro-dip lacquer coating.

### DETAILED DESCRIPTION OF CERTAIN EMBODIMENTS OF THE INVENTION

The reactive, thermosetting binder compositions used according to the invention comprise

one or more liquid rubbers and/or solid rubbers or elastomers,

vulcanizing agents, vulcanization accelerators, catalysts,

fillers,

optionally tackifying agents and/or adhesion promoters,

optionally blowing agents,

optionally extender oils,

optionally anti-aging agents,

optionally rheology auxiliaries.

The liquid rubbers or elastomers here contain at least one olefinically unsaturated double bond per molecule. They can be chosen here from the following group of homo- and/or copolymers: polybutadienes, in particular the 1,4- and 1,2-poly-butadienes, polybutenes, polyisobutylenes, 1,4- and 3,4-polyisoprenes, styrene/butadiene copolymers, butadiene/acrylonitrile copolymers and ethylene/propylene/diene rubber (EPDM), it being possible for one or more of these polymers to have terminal and/or (randomly distributed) lateral functional groups. Examples of such functional groups are hydroxyl, amino, mercapto, carboxyl, carboxylic acid anhydride or epoxide groups. The molecular weight of these liquid rubbers is typically below 40,000, preferably between 900 and 10,000. The content of liquid rubber in the total composition depends here on the desired rheology of the non-cured composition and the desired mechanical rigidity of the laminated body and the necessary stiffening or reinforcing action of the cured laminated body-substrates composite. The content of liquid rubber or elastomer usually varies between 5 and 50 wt. % of the total formulation. It has proved expedient here to employ mixtures of liquid rubbers of various molecular weights and various configurations in respect of the remaining double bonds. In the particularly preferred formulations, a proportion of a liquid rubber component with hydroxyl groups, carboxyl groups or acid anhydride groups is employed to achieve optimum adhesion to the diverse substrate. At least one of the liquid rubbers should contain a high content of cis-1,4-double bonds, and a further one should contain a high content of vinyl double bonds.

Suitable solid rubbers have a significantly higher molecular weight (MW=100,000 or higher), compared with the liquid rubbers, and examples of suitable solid rubbers are polybutadiene, preferably with a very high content of cis-1,4-double bonds (typically above 95%), styrene/butadiene rubber, butadiene/acrylonitrile rubber, EPDM, synthetic or naturally occurring isoprene rubber, butyl rubber or polyurethane rubber. The content of solid rubber can be 3 to 20 wt. %, preferably 3 to 10 wt. % of the total binder composition.

The compositions according to the invention can optionally also comprise finely divided thermoplastic polymer powders. Examples of suitable thermoplastic polymers are polypropylene, polyethylene, thermoplastic polyurethanes, methacrylate copolymers, styrene copolymers, polyvinyl chloride, polyvinyl acetal and, in particular, polyvinyl acetate and copolymers thereof, such as, for example, ethylene/vinyl acetate copolymers. Although the particle size or particle size distribution of the polymer powders does not seem to be particularly critical, the average particle size should be less than 1 mm, preferably less than 350 μm. The amount of thermoplastic polymer powder optionally added is between 2 and 20 wt. %, preferably between 2 and 10 wt. %.

The crosslinking or curing reaction of the rubber composition and the foaming have a decisive influence on the sheet-stiffening action of the laminated body, and the vulcanization system and the blowing agent composition must therefore be chosen and matched particularly carefully. A large number of vulcanizing agents in combination with elemental sulfur and also vulcanization systems without free sulfur are suitable for the vulcanization system. The latter systems include the vulcanization systems based on thiuram disulfides, organic peroxides, polyfunctional amines, quinones, p-benzoquinone-dioxime, p-nitrosobenzene and dinitrosobenzene, or also crosslinking with (blocked) diisocyanates. However, vulcanization systems based on elemental sulfur and organic vulcanization accelerators as well as zinc compounds are very particularly preferred. The pulverulent sulfur is employed here in amounts of 1 to 15 wt. %, based on the total composition, and amounts of between 3 and 8% are particularly preferably employed. Suitable organic accelerators are dithiocarbamates (in the form of their ammonium or metal salts), xanthogenates, thiuram compounds (monosulfides and disulfides), thiazole compounds, aldehyde/amine accelerators (e.g. hexamethylenetetramine) and guanidine accelerators, for example diphenylguanidine, and dibenzothiazyl disulfide (MBTS), by itself or optionally as a mixture with other accelerators, such as e.g. zinc dibenzyldithiocarbamate (ZBEC), is very particularly preferred. These organic accelerators are employed in amounts of between 0.1 and 10 wt. %, based on the total formulation, preferably between 0.2 and 8 wt. %. In the case of zinc compounds which act as accelerators, a choice can be made between zinc salts of fatty acids, zinc dithiocarbamates, basic zinc carbonates and, in particular, finely divided zinc oxide. The content of zinc compounds is in the range of between 3 and 20 wt. %, preferably between 3 and 7 wt. %. Further typical rubber vulcanization auxiliaries, such as fatty acids (e.g., stearic acid), can additionally be present in the formulation.

In principle all the usual blowing agents can be used to achieve foaming during the curing operation, and examples of organic blowing agents are azo compounds, N-nitroso compounds, sulfonyl hydrazides or sulfonyl semicarbazides. For the azo compounds to be used according to the invention, there may be mentioned by way of example azobisisobutyronitrile and, in particular, azodicarboxamide, from the class of nitroso compounds there may be mentioned by way of example di-nitrosopentamethylenetetramine, from the class of sulfohydrazides there may be mentioned 4,4′-oxybis(benzenesulfonic acid hydrazide), diphenyl-sulfone-3,3′-disulfohydrazide or benzene-1,3-disulfohydrazide, and from the class of semicarbazides there may be mentioned p-toluenesulfonyl semicarbazide. However, the expandable hollow microbeads of plastic based on polyvinylidene chloride copolymers or acrylonitrile/(meth)acrylate copolymers are particularly preferred, these being commercially obtainable e.g. under the names “Dualite” or “Expancel” from Pierce & Stevens or Casco Nobel. The blowing agents are employed in amounts of between 0.1 and 2 wt. %, preferably between 0.2 and 1.5 wt. %.

Although the compositions according to the invention as a rule already have a very good adhesion to the substrates to be stiffened on the basis of the preferred content of liquid rubber with functional groups, tackifying agents and/or adhesion promoters can be added if necessary. Hydrocarbon resins, phenolic resins, terpene-phenolic resins, resorcinol resins or derivatives thereof, modified or non-modified resin acids or esters (abietic acid derivatives), polyamines, polyaminoamides, anhydrides and anhydride-containing copolymers, for example, are suitable for this. The addition of poly-epoxy resins in small amounts can also improve the adhesion to some substrates. However, the solid epoxy resins with a molecular weight of above 700 in finely ground form are then preferably employed for this purpose. If tackifying agents or adhesion promoters are employed, the nature and amount thereof depend on the polymer composition of the laminated body and the substrate to which this is applied. Typical tackifying resins (tackifiers), such as e.g., terpene-phenolic resins or resin acid derivatives, are used in concentrations of between 5 and 20 wt. %, and typical adhesion promoters, such as polyamines, polyaminoamides or phenolic resins or resorcinol derivatives, are used in the range of between 0.1 and 10 wt. %.

The compositions according to the invention are preferably free from plasticizers and extender oils. However, it may be necessary to influence the rheology of the non-cured composition and/or the mechanical properties of the cured composition by addition of so-called extender oils, i.e. aliphatic, aromatic or naphthenic oils. This influencing is preferably indeed achieved by expedient choice of the low molecular weight liquid rubbers or by the co-use of low molecular weight polybutenes or polyisobutylenes. If extender oils are employed, amounts in the range of between 2 and 15 wt. % are used.

The fillers can be chosen from a large number of materials, and there may be mentioned in particular here chalks, naturally occurring, ground or synthetic, precipitated calcium carbonates, calcium-magnesium carbonates, silicates, barite and carbon black. It may optionally be expedient for at least a portion of the fillers to be pretreated on the surface, and in particular a coating with stearic acid has proved to be expedient in the case of the various calcium carbonates and chalks in order to reduce the moisture introduced and to reduce the sensitivity of the cured composition to moisture. The compositions according to the invention can optionally also comprise between 1 and 20 wt. %, preferably between 1.5 and 5 wt. % of calcium oxide. The total content of fillers in the formulation can vary between 10 and 70 wt. %, and the preferred range is between 25 and 60 wt. %.

Conventional stabilizers or anti-aging agents, such as, e.g., sterically hindered phenols or amine derivatives, can be employed against thermal, thermo-oxidative or ozone degradation of the compositions according to the invention, and typical amounts ranges for these stabilizers are 0.1 to 5 wt. %.

Although the rheology of the compositions according to the invention can usually be brought into the desired range by the choice of fillers and the ratio of amounts of the low molecular weight liquid rubbers, conventional rheology auxiliaries, such as, e.g., pyrogenic silicas, bentones or fibrillated or pulped short fibers, can be added in the range of between 0.1 and 7%. Further conventional auxiliary substances and additives can moreover be used in the compositions according to the invention.

Film- or fiber-containing sheet-like structures are used as reinforcing agents for the multi-layered shaped articles according to the invention. The films here can be metal films, for example aluminum films, steel films, copper films or brass films. It is also possible to use films of plastic or polyester, polyamide, polypropylene or polyimide. Nonwovens, woven fabric or knitted fabric of aramid fibers, carbon fibers, glass fibers, polyamide fibers, polyethylene fibers, polypropylene fibers or polyester fibers can be used as fiber-containing sheet-like structures.

If the binder layer has an intrinsic tackiness at room temperature or storage and transportation temperatures (up to about 50° C.), it may furthermore be expedient to cover at least one side of the binder layer by a protective film for efficient storage and transportability of the multi-layered planar shaped articles according to the invention. This protective film here can comprise, in a conventional manner, (siliconized) paper or plastic, but a film of hot-melt adhesive can also be used, this being heated shortly before application of the shaped article, as a result of which it becomes tacky on the surface and can remain on the shaped article. For this purpose, the hot-melt adhesive should be compatible with the rubber composition of the shaped article.

For production of the shaped articles according to the invention, the binder composition is first mixed homogeneously in a conventional manner which is known per se in suitable mixing units, such as planetary mixers, kneaders or suitable mixing extruders.

The homogenized binder mixture is then extruded in the envisaged layer thickness on to the reinforcing agent, i.e. the film or the fiber-containing sheet-like structure, and, if necessary because of the intrinsic tackiness, the binder side—i.e., the side facing away from the reinforcing agent layer—is provided with a protective film. The binder layer can be applied here to the reinforcing agent in a conventional manner by extrusion through a slot die, a doctor blade or by roller application, application through a slot die is preferred. The shaped article produced in this manner can either be wound up as continuous goods on to a spool, or cut or stamped into individual shaped pieces.

Typical binder compositions for the production of the shaped articles according to the invention comprise:

| | |
|---|---|
| 0-20.0 wt. % | cis-1,4-polybutadiene (solid) |
| 3.0-20.0 wt. % | zinc oxide, |
| 2.0-20.0 wt. % | calcium oxide, |
| 0.1-2.0 wt. % | antioxidant, |
| 0.5-0.5 wt. % | pigment, preferably carbon black, |
| 5.0-60.0 wt. % | calcium carbonate, ground |
| 5.0-40.0 wt. % | precipitated calcium carbonate, |
| | coated with stearate, |
| 2.0-20.0 wt. % | polybutadiene, liquid, MW approx. |
| | 1,800, cis-1,4 approx. 75%, |
| 1.0-30.0 wt. % | polybutadiene with active carboxyl |
| | groups, MW approx. 1,700, |
| 2.0-20.0 wt. % | EPDM, MW 5,700-8,700, propylene |
| | content 49-59%, |
| 2.0-40.0 wt. % | low molecular weight, stereospecific |
| | polybutadiene oil, MW 1,800, vinyl 50%, |
| 1.0-10.0 wt. % | sulfur, |
| 0.2-5.0 wt. % | MBTS, optionally as a mixture with |
| | other accelerators, |
| 0.1-2.0 wt. % | hollow microbeads |

the sum total of the binder constituents being 100 wt. %.

A preferred field of use for the thermosetting, optionally foamable reactive compositions according to the invention is so-called bare construction in the automobile industry. The components which later form hollow spaces in the vehicle body are also readily accessible here, so that application of the preformed laminated bodies to the planar regions of the vehicle body to be stiffened can be carried out manually. It is also possible for the extrusion of the binder and the subsequent application of the reinforcing agent to the binder to be carried out directly on to the substrate in the production line of the automobile factory. This can be carried out largely automatically with suitable automated extrusion systems and/or robots. The process temperatures of the various lacquering ovens are then available for the curing and foaming reaction of the compositions, i.e., a temperature range of between 80° C. and 240° C. for about 10 to 35 minutes, and the passage of the vehicle body or of the components through the so-called “EC oven” preferably serves to cure and optionally foam the compositions according to the invention, i.e., temperatures of between 160° C. and 200° C. are suitable.

The planar shaped articles according to the invention are used for sheet- or frame-stiffening for the most diverse uses in automobile construction, for example, for stiffening regions of boot lids, engine bonnets, door areas, roof areas and vehicle frames. A stiffening performance up to a factor of 6, based on the non-stiffened metal sheet, is achieved by an appropriate mixture of solid and liquid rubbers in combination with an adequate amount of sulfur and accelerators as vulcanizing agents or also sulfur-free vulcanizing agents, and strengths of up to 6 MPa for the shaped article are achieved.

The invention is to be explained in more detail in the following embodiment examples, where the choice of the examples is not intended to represent a limitation of the scope of the subject matter of the invention, but is merely intended to represent individual embodiments and advantageous effects of the invention by way of a model. Unless stated otherwise, all the amounts stated in the following examples are parts by weight or percentage by weight.

### EXAMPLE 1

The following constituents were mixed in an extruder in a conventional manner until the mixture was homogeneous:

| | |
|---|---|
| 3.00 parts | zinc oxide |
| 2.80 parts | calcium oxide |
| 0.55 part | antioxidant (sterically hindered phenol) |
| 0.55 part | carbon black |
| 52.3 parts | calcium carbonate, ground |
| 9.00 parts | calcium carbonate, precipitated, coated |
| | with stearate |
| 9.00 parts | polybutadiene, liquid, MW approx. 1,800, |
| | cis-1,4 approx. 75% |
| 5.00 parts | polybutadiene modified with maleic |
| | anhydride, MW approx. 1,000, cis-1,4 |
| | approx. 10-20% |
| 7.60 parts | EPDM, MW 5,700-8,700, propylene 49-59%, |
| | diene 8-11% |
| 3.00 parts | tackifying agent, |
| 4.80 parts | sulfur |
| 0.50 parts | MBTS |
| 1.90 parts | expandable hollow microbeads |

The homogeneous mixture was extruded on to a fabric of glass fiber to a layer thickness of 1.5 mm. A shaped article with the dimensions 25 mm×100 mm was then cut out of this laminated body. This was pressed with the tacky binder layer on to a steel sheet 0.8 mm thick and cured at temperatures of 170° C. or 200° C. for a period of 25 min or 60 min in a hot circulating air oven. The following measurement results were achieved in the three-point bending test in accordance with DIN 53293 or EN 63 on the metal sheet stiffened in this way:

| | |
|---|---|
| Curing at 25 min 175° C.: | approx. 150 N after 1 mm bending |
| | approx. 190 N maximum value (after |
| | approx. 6 mm bending) |
| Curing at 60 min 200° C.: | approx. 150 N after 1 mm bending |
| | approx. 190 N maximum value (after |
| | approx. 5 mm bending) |
| 0.8 mm steel sheet: | approx. 30 N after 1 mm bending |
| | approx. 190 N after approx. 5 mm |
| | bending |

What is claimed is:

1. A multi-layered, planar shaped article comprising at least one thermosetting binder layer and at least one layer comprising at least one reinforcing agent, wherein the thermosetting binder layer comprises at least one vulcanizing agent and at least one liquid polyene having a molecular weight in the range from 900 to about 40,000 and containing olefinic double bonds selected from the group consisting of 1,2-polybutadiene, 1,4-polybutadiene, polyisoprene, polybutene, polyisobutylene, copolymers of butadiene and/or isoprene with styrene and/or acrylonitrile and copolymers of acrylic acid esters with dienes.

2. A shaped article as claimed in claim 1, wherein the at least one liquid polyene additionally contains at least one functional group selected from the group consisting of carboxyl groups, carboxylic acid anhydride groups, hydroxyl groups, amino groups, mercapto groups and epoxide groups.

3. A shaped article as claimed in claim 1, wherein the thermosetting binder layer additionally comprises at least one solid rubber in an amount of 3 to 20 wt. %, based on the total composition.

4. A shaped article as claimed in claim 3, wherein said at least one solid rubber is selected from the group consisting of cis-1,4-polybutadiene, styrene/butadiene rubber, synthetic isoprene rubber, natural rubber, ethylene/propylene/diene rubber (EPDM), nitrile rubber, butyl rubber and acrylic rubber.

5. A shaped article as claimed in claim 1, wherein said thermosetting binder layer comprises sulfur, at least one organic vulcanization accelerator and at least one zinc compound.

6. A shaped article as claimed in claim 1, wherein the thermosetting binder layer comprises 1 wt. % to 15 wt. % pulverulent sulfur, 0.1 wt. % to 10 wt. % of one or more organic accelerators and 3 wt. % to 20 wt. % of one or more zinc compounds, the wt. % being based on the total thermosetting binder layer.

7. A shaped article as claimed in claim 1, wherein the thermosetting binder layer comprises at least one vulcanizing agent selected from the group consisting of peroxides, polyfunctional amines, quinones, p-benzoquinone-dioxime, p-nitrosobenzene and dinitrobenzene.

8. A shaped article as claimed in claim 1, additionally comprising at least one additive selected from the group consisting of fillers, rheology auxiliaries, extender oils, adhesion promoters and anti-aging agents.

9. A shaped article as claimed in claim 1, wherein the thermosetting binder layer is intrinsically tacky at room temperature.

10. A shaped article as claimed in claim 1, wherein the at least one reinforcing agent is a film or a fiber-containing sheet-like structure.

11. A shaped article as claimed in claim 1, wherein the at least one reinforcing agent is a film comprised of a material selected from the group consisting of aluminum, steel, copper, brass, polyester, polyamide, polypropylene and polyimide.

12. A shaped article as claimed in claim 1, wherein the at least one reinforcing agent is a fiber-containing sheet-like structure comprised of fibers selected from the group consisting of aramid fibers, carbon fibers, glass fibers, polyamide fibers, polyethylene fibers, polypropylene fibers and polyester fibers.

13. A shaped article as claimed in claim 1, wherein the thermosetting binder layer is covered by a protective film on at least one side.

14. A shaped article as claimed in claim 1, wherein the thermosetting binder layer comprises 3 wt. % to 8 wt. % pulverulent sulfur, 0.2 wt. % to 8 wt. % of one or more organic accelerators and 3 wt. % to 7 wt. % of one or more zinc compounds, the wt. % being based on the total thermosetting binder layer.

15. A shaped article as claimed in claim 1, wherein the thermosetting binder layer comprises at least one blowing agent.

16. A shaped article as claimed in claim 1, wherein the thermosetting binder layer comprises at least one tackifying agent.

17. A shaped article as claimed in claim 1, wherein the at least one liquid polyene has a molecular weight of between 900 and 10,000.

18. A shaped article as claimed in claim 1, wherein the thermosetting binder layer is comprised of from 5 to 50% by weight of one or more liquid polyenes.

19. A shaped article as claimed in claim 1, wherein the thermosetting binder layer is comprised of a mixture of liquid polyenes each having a molecular weight in the range between 900 to 40,000 and wherein said mixture comprises at least one liquid polybutadiene, at least one liquid polybutadiene having active carboxyl groups, and at least one ethylene/propylene/diene rubber.

20. A process for stiffening or reinforcing a planar structural component comprised of metal or plastic, said process comprising:
a) applying the shaped article of claim 1 to the planar structural component; and
b) curing the thermosetting binder layer.

21. A process as claimed in claim 20, comprising the additional step prior to step a) of removing a protective film from the thermosetting binder layer of the shaped article.

22. A process as claimed in claim 20, wherein the thermosetting binder layer is cured at a temperature of between 110° C. and 210° C.
